(19) United States
(12) Patent Application Publication
(10) Pub. No.: US 2009/0155745 A1
(43) Pub. Date: Jun. 18, 2009

(54) Tooth implant with a primary and a secondary crown

(76) Inventor: Robert Laux, Sulzbach/Murr (DE)

Correspondence Address: KLAUS J. BACH, 4407 TWIN OAKS DRIVE, MURRYSVILLE, PA, 15668, US

(21) Appl. No.: 12/378,464

(22) Filed: Feb. 13, 2009

Related U.S. Application Data
(63) Continuation-in-part of application No. PCT/EP2007/006920, filed on Aug. 6, 2007.

(30) Foreign Application Priority Data
Aug. 15, 2008 (DE) 10 2006 038 395.8

(51) Int. Cl. A61C 8/00

(52) U.S. Cl. 433/174

(57) ABSTRACT

In a tooth implant comprising a primary crown for mounting on a base carrier implanted into a patient's jaw and a secondary crown mounted onto the primary crown for supporting a bridge or prosthesis, the primary crown has a circular or ball-shaped projection and the secondary crown has a recess of a complementary configuration receiving the projection of the primary crown so that the secondary crown is pivotally supported by the primary crown for permitting adjustments during installation of the prosthesis or bridge onto the secondary crown.

This is a Continuation-In-Part Application of pending International Patent Application PCT/EP2007/006920 filed Aug. 6, 2007 and claiming the priority of German patent application 10 2006 08 395.8 filed Aug. 15, 2006.

### BACKGROUND OF THE INVENTION

The invention relates to a tooth implant with two implant parts comprising a primary and a secondary crown which are interconnected and of which the secondary crown is adapted to support a tooth prosthesis or a bridge and has in at least one cross-sectional plane an at least partially circular shape for pivotally supporting the prosthesis or the bridge.

DE 10 2004 018 512 A1 discloses such a tooth implant wherein a base carrier is to be implanted into the jaw of a patient and a primary crown is mounted onto the base carrier for example by a screw connection. Onto the primary crown, which is cone-shaped, a secondary crown is placed so as to form a support structure for a prosthesis or a bridge. The connection between the primary crown and the secondary crown is established by way of the cone-shaped section of the primary crown which extends into a corresponding cavity in the secondary crown. Opposite cone areas of the cone-shaped section of the primary crown have different cone angles which, within a small angular range, provides for a balancing or compensation capability in the tooth implant.

U.S. Pat. No. 5,480,304 discloses a tooth implant with two implant parts in the form of a primary and a secondary crown which are interconnected and of which the primary crown is supported by a basic support member which is anchored in the jaw of a patient, whereas the secondary crown is provided with two ball heads. One of the ball heads is connected to the primary crown and the other is connected to a pin, which carries a prosthesis. The arrangement provides for different degrees of freedom of movement between the primary crown and the secondary crown on one hand and between the secondary crown and the pin on the other. It is however a disadvantage that the design is relatively complicated and extends over a relatively large length in axial direction.

Based on this state of the art, it is the object of the present invention to provide a tooth implant including a primary crown and a secondary crown arrangement wherein angular deviations between the implant axes of the primary and secondary crowns and a prosthesis or bridge disposed thereon can be accommodated without detrimentally affecting the functionality and durability of the connection.

Expediently, an angular adjustability in different spatial directions is to be provided in order to prevent cogging of the prosthesis or the bridge during installation or removal.

### SUMMARY OF THE INVENTION

In a tooth implant comprising a primary crown for mounting on a base carrier implanted into a patient's jaw and a secondary crown mounted onto the primary crown for supporting a bridge or prosthesis, the primary crown has a circular or ball-shaped projection and the secondary crown has a recess of a complementary configuration receiving the projection of the primary crown so that the secondary crown is pivotally supported by the primary crown for permitting adjustments during installation of the prosthesis or bridge onto the secondary crown.

The tooth implant according to the invention comprises two implant parts in the form of a primary and a secondary crown which are to be joined. On the secondary crown, a prosthesis or bridge is mounted wherein the outer surface of the secondary crown, which carries the prosthesis or bridge, is in at least one cross-sectional plane almost, or essentially, circular or, respectively, partially circular and is accommodated in a corresponding support cavity of the prosthesis or, respectively, a cover structure in a pivotal manner. In this way, a certain pivotability of the secondary crown with respect to the prosthesis or, respectively, the bridge is obtained, whereby an additional degree of freedom or respectively, movement capability is provided and the secondary crown can be adjusted angularly depending on the anatomical conditions with respect to the longitudinal axis of the tooth implant. In this way, the implant installation can be improved in a functional as well as technical respect.

The partially circular or spherical shape of the outer surface of the secondary crown and the complementary support structure in the prosthesis or the cover structure provides for an additional joint which is obtained by simple design features. The support structure is established by a cavity formed in the prosthesis or, respectively, the cover structure and accommodating the partially circular or spherical outer surface of the secondary crown. This arrangement is of a particularly simple design.

In accordance with a preferred further development, the outer surface of the secondary crown is ball-shaped or at least partially ball-shaped and pivotally accommodated in a correspondingly complementary support structure in the prosthesis or respectively, bridge or cover structure. The partially ball-shaped structure is to be understood to be a three-dimensional embodiment of the partially circular structure whereby not only one but altogether two additional rotational degrees of freedom of motion in different spatial directions are obtained. The secondary crown is, as a result, supported so as to be pivotable with respect to the prosthesis or, respectively, the bridge in two pivot directions. In this way, additional adjustment possibilities for the secondary crown with respect to the prosthesis or, respectively, the bridge are obtained. As a result of the adjustability, it is possible for the secondary crown to accommodate adjustment movements during its installation or its removal to avoid cogging of the secondary crown with the respective primary crown. This is particularly true when several implants with primary and secondary crowns are involved which have diverging axes. The advantage or respectively, possible embodiments in connection with the circular embodiments mentioned above also apply to the ball- or partially ball-shaped embodiments.

The support structure in the prosthesis or, respectively, the bridge is complementary, at least in sections, to the outer surface of the secondary crown so that, in the complementarily formed sections, the outer surface of the secondary crown abuts the inner surface of the support structure over a certain area via which the forces effective between the implant parts are evenly distributed in order to avoid surface pressure peaks.

The secondary crown may be accommodated at least essentially without play in the support structure of the prosthesis or, respectively, the cover or bridge in order to prevent an undesirable wiggling of the prosthesis or the bridge. It is however possible that a certain play-fit is desired, in order to transmit chewing forces to a greater extent via the prosthesis to the jaw gum surface with a certain resiliency.

In a further advantageous embodiment, the secondary crown is provided with a projection which projects from the outer surface thereof with a certain play into a cavity formed in the support structure of the cover or the prosthesis or bridge. With such room for movement, the secondary crown can pivot slightly in the given degrees of freedom with respect to the prosthesis or, respectively the bridge. However, the pivot movement is limited by an abutment of the projection of the outer surface of the secondary crown on the side walls of the recess in the support structure. The stop formed thereby forms an effective simple limit for the relative pivot movement of the secondary crown with respect to the prosthesis or, respectively, the bridge.

In another embodiment a circular or at least partially circular and preferably ball- or partially ball-shaped section is provided on the primary crown which extends into a complementarily shaped recess in the secondary crown, whereby additional rotational movement capabilities between the primary and the secondary crown are provided. In comparison with the state of the art, additional movement possibilities for the adjustment of the relative position between the primary and the secondary crown are obtained by this arrangement. With a circular arrangement, one rotational movement possibility and with a ball-like arrangement two rotational movement possibilities are provided.

In a preferred further embodiment, the spherical recess in the secondary crown, into which the ball head provided on the primary crown can be inserted, is arranged eccentrically with respect to the ball-shaped outer surface of the secondary crown. In this embodiment, the secondary crown has two ball-shaped areas, each of which is part of a support structure, one at the outer surface for the connection to the prosthesis or, respectively, bridge and the other at the inner surface of the recess for receiving the ball head of the primary crown, the two ball-shaped areas being preferably arranged eccentrically relative to each other. The eccentricity between the ball-shaped areas provides for an additional translatory component of movement of the bridge or, respectively, the prosthesis relative to primary crown. The ball-shaped engagement surfaces between the primary crown and the secondary crown on one hand, and between the secondary crown and the prosthesis or, respectively, the bridge on the other hand, each permit only rotational movement; because of the eccentricity however, the prosthesis or, respectively, the bridge may also have a translatory movement component.

In accordance with an advantageous further embodiment, the ball-shaped section of the primary crown which extends into the complementarily formed recess in the secondary crown is elastically resilient, so that the ball-shaped section can be inserted into the recess also if the recess extends over an angular range >180° and, as a result, forms an undercut. Because of the elasticity, the ball-shaped section of the primary crown can be compressed and inserted into the correspondingly shaped recess in the secondary crown. After insertion, the ball-shaped section assumes again its original shape whereby a form-locking connection between the primary and the secondary crown is established. Vice versa, the recess walls may be elastically resilient. Because of the elasticity the hollow ball-shaped recess of the secondary crown can be expanded and the ball-shaped section of the primary crown can be inserted. After insertion, the hollow ball-shaped recess of the secondary crown resumes, its original shape whereby a form-locking connection between the primary and the secondary crown is established.

The elasticity of the ball-shaped sections of the primary crown and/or the secondary crown is achieved by a selection of an elastic material and/or a particular design of those components. As material, for example, hard rubber or another resilient and elastic, but sufficiently rigid, material may be used. In an advantageous arrangement recesses are formed in the ball-shaped sections of the primary crown and/or secondary crown which provide for a spring effect so that the respective sections can be compressed or expanded. In such an arrangement, the primary and secondary crown may consist of metal. Basically, however, hard rubber or another material with a good measure of elasticity may also be used in such an arrangement.

The invention and expedient embodiments thereof will be described below on the basis of the accompanying drawings.

### BRIEF DESCRIPTION OF THE DRAWINGS

FIG. 1 is a cross-sectional view of tooth implant with a primary crown, a secondary crown disposed on the primary crown, and a prosthesis mounted on the secondary crown wherein the outer surface of the secondary crown is partially ball-shaped and is accommodated in a bearing structure disposed in the prosthesis.

FIG. 2 shows in a cross-sectional view, a modified embodiment of a tooth implant with a primary and a secondary crown, wherein the primary crown is sleeve-shaped and is mounted by a central screw,

FIG. 3 is a cross-sectional view of another embodiment of a tooth implant with a ball-like connection between the primary and the secondary crown on one hand, and the secondary crown and the prosthesis on the other, and

FIG. 4 is a cross-sectional view of still another embodiment of a tooth implant which is similar in design to that of FIG. 3, but which additionally is provided with a projection formed on the secondary crown and extending into a corresponding cavity formed in the support structure of the prosthesis.

### DETAILED DESCRIPTION OF THE EMBODIMENTS

In the figures functionally identical parts are identified by the same reference numerals.

The tooth implant 1 as shown in FIG. 1 comprises a base carrier 2, which is to be anchored in the jaw of a patient, a primary crown 3 screwed into the base carrier 2, a secondary crown 4 connected to the primary crown 3 and a prosthesis 5 or bridge or similar structure disposed on the secondary crown 4. The screw connection between the base carrier 2 and the primary crown 3 is obtained by an internal thread provided in the base carrier 2 and an external thread provided on the primary crown 3 and threaded into the internal thread of the base carrier. The connection between the primary crown 3 and the secondary crown 4 is established by way of a cone section 11 projecting from the primary crown 3 into a complementarily shaped accommodation recess 12 formed into the secondary crown 4. Between the cone section 11 and the wall of the accommodation recess 12, a frictional engagement is to be achieved for firmly holding the prosthesis or bridge in position. The two parts (3, 4) are to be held in force-locking engagement.

The outer surface 6 of the secondary crown is partially ball-shaped. It is part of a ball-joint which allows for a rotational pivot movement between the secondary crown 4 relative to the prosthesis or, respectively, bridge about at least two axes which extend each in a direction normal to the longitudinal axis 13 of the tooth implant 1. The outer surface 6 is accommodated in a bearing structure 7 in areal contact therewith which bearing structure 7 is installed in a cavity 8 of the bridge or, respectively, prosthesis 5. The outer surface 6 of the secondary crown 4 and the bearing structure 7 together form a ball joint.

The secondary crown 4 is provided with a projection 9 which extends from the surface 6 of the secondary crown opposite the recess 12 for accommodating the cone section 11 of the primary crown 3 into the cavity 10 of the bearing structure 7 when the implant is assembled as shown in FIG. 1. The projection 9 is received in the cavity 10 with some play so that relative movement between the prosthesis 5 and the primary crown 4 is possible with the limits established by the play. The radius of the outer contour 6 of the secondary crown 4 is indicated by an arrow R.

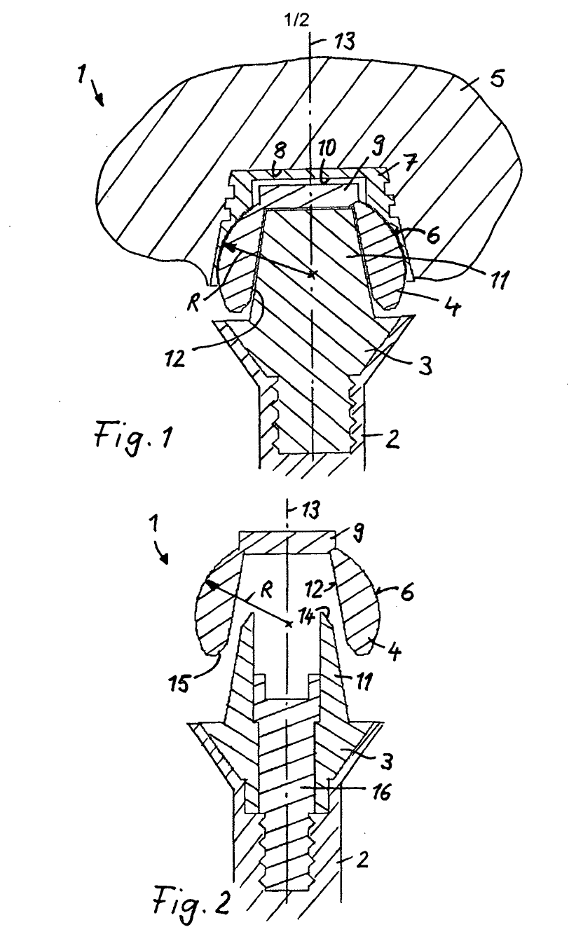

FIG. 2 shows a modified embodiment of a tooth implant 1 wherein the primary crown 3 has a sleeve-like shape and is mounted to the base carrier 2 via a connecting screw 16 which is screwed into the base carrier 2. The secondary crown 4 is identical to the secondary crown shown in FIG. 1. As shown in FIG. 2, the front end of the cone-shaped section 11 of the primary crown 3 is provided with a chamfer 14. A chamfer 15 is also provided at the bottom end of the secondary crown 4. The chamfers 14 and 15 facilitate joining of the primary crown 3 and the secondary crown 4 in case of a divergence between two or more implants.

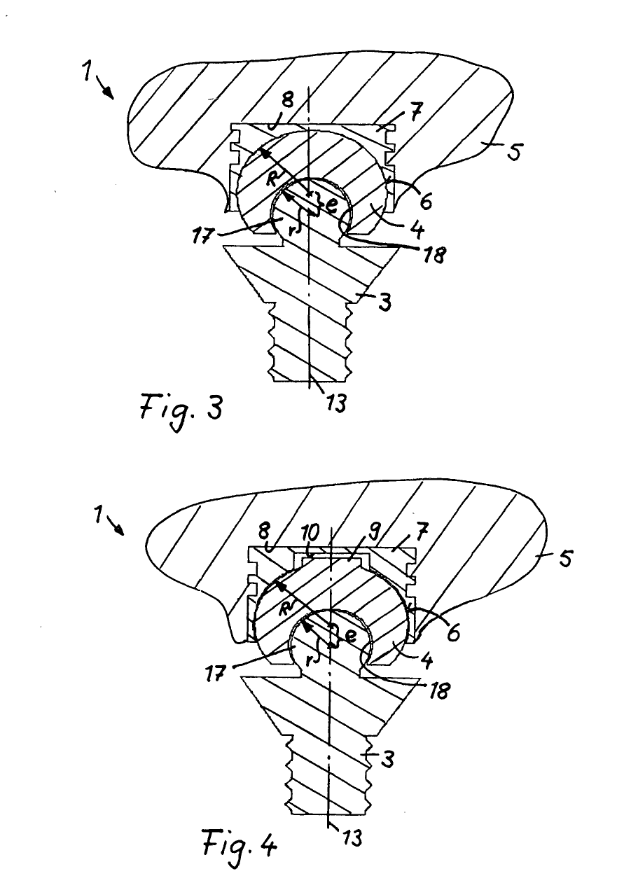

FIG. 3 shows a further embodiment of a tooth implant 1, wherein the connection between the primary crown and the secondary crown 4 is in the form of a ball joint. The secondary crown 4 is provided with a spherical cavity 18, which, in cross-section, extends over an angular area of >180° and in which a ball-shaped section 17 projecting from the top of the primary crown 3 is pivotally accommodated. The ball-shaped section or, respectively, the ball head 17 of the primary crown 3 has a radius r and also the spherical cavity 18 has the same radius r so that the ball head 17 is received in the cavity 18 without play. However, the radii may be different when a fitting with play is desired.

The outer contour 6 of the secondary crown 4 is also ball-shaped and pivotally accommodated in the bearing structure 7 which is installed in the cavity 8 of the prosthesis or, respectively, cover structure 5. Different from the embodiment of FIG. 1 however, the outer contour 6 of the secondary crown 4 is throughout ball-shaped without the projection. Also, the bearing structure 7 has a corresponding spherical shape. The radius of the outer contour 6 or the corresponding spherical inner bearing surface 7 is designated by the arrow R.

As further shown in FIG. 3, the two ball-shaped surface areas of the secondary crown 4 that is the spherical cavity 18 within and the ball-shaped outer contour 6 are arranged eccentrically, the eccentricity being indicated by the letter e. As a result of the eccentricity e, the prosthesis 5 can, with respect to the primary crown 3, not only be rotated about two axes extending normal to the longitudinal axis 13, but additionally a movement with a translatory component can be obtained when the secondary crown 4 is pivoted relative to the ball-shaped projection of the primary crown 3 and, at the same time, the secondary crown 4 is rotated in the bearing structure 7 of the cover structure or, respectively, the prosthesis 5 as the respective pivot axes are arranged at a distance e from each other.

The embodiment according to FIG. 4 corresponds essentially to that of FIG. 3 so that the description of FIG. 3 also applies to FIG. 4. The only difference resides in the arrangement on the outer contour 6 of the secondary crown 4—like in the embodiments of FIGS. 1 and 2—of a projection 9 which extends with play into a corresponding cavity 10 in the bearing structure 7.

What is claimed is:

1. A tooth implant comprising a primary crown (3) for a mounting on a base carrier (2) implanted into a patients jaw, a secondary crown (4) mounted onto the primary crown (3) and a bridge or prosthesis (5) supported by the secondary crown (4), the secondary crown (4) having an outer contour (6) which is, at least in one cross-sectional plane, at least partially circular, and the prosthesis or bridge (5) having a cavity (8) including a bearing structure (7) having a configuration corresponding to the at least partially circular contour (6) of the secondary crown (4) and being pivotally captivated in the cavity (8) of the bearing structure (7) for pivotally supporting the prosthesis or bridge (5) and permitting rotational movement between the secondary crown (4) and the bearing structure (7) together with the prosthesis or bridge (5).

2. The tooth implant according to claim 1, wherein the outer contour (6) of the secondary crown (4) is partially ball-shaped and the bearing structure (7) in the cavity (8) is partially spherical and receives the partially ball-shaped secondary crown (4) for supporting the prosthesis or bridge (5) pivotally in at least two planes.

3. The tooth implant according to claim 2, wherein the bearing structure cavity (8) is complementary to the ball-shaped contour (6) of the secondary crown (4).

4. The tooth implant according to claim 1, wherein the bearing structure (7) is a separate component installed in the cavity (8) of the prosthesis or bridge (5).

5. The tooth implant according to claim 1, wherein the secondary crown (4) is disposed in the bearing structure (7) without play.

6. The tooth implant according to claim 1, wherein the bearing structure (7) includes a recess (10) and the secondary crown (4) is provided with a projection (9) projecting from the outer contour (6) of the secondary crown into the recess (10) in the bearing structure (7).

7. The tooth implant according to claim 6, wherein the projection (9) is accommodated in the recess (10) with play.

8. The tooth implant according to claim 1, wherein the secondary crown (4) is mounted onto the primary crown (3) in a form-locking manner.

9. The tooth implant according to claim 1, wherein the primary crown (3) includes a cone section (11) and the secondary crown has a conical cavity (12) complementary to the cone section (11) of the primary crown (3) and tightly receiving the cone section (11) of the primary crown (3).

10. The tooth implant according to claim 2, wherein, for the connection between the primary crown (3) and the secondary crown (4), the primary crown (3) includes a ball-shaped projection (17) and the secondary crown (4) includes a complementary spherical cavity (18) in which the ball-shaped projection (17) of the primary crown is received.

11. The tooth implant according to claim 10, wherein the spherical cavity (18) in the secondary crown (4) is eccentric with respect to the ball-shaped contour (6) of the secondary crown (4).

12. The tooth implant according to claim 10, wherein at least one of the ball-shaped projection (17) of the primary crown (3) and the walls of the spherical cavity (18) of the secondary crown (4) are elastically resilient.

13. The tooth implant according to claim 12, wherein at least one of the ball-shaped projection (17) of the primary crown (3) and the secondary crown (4) consists of elastically resilient material such as hard rubber.

14. The tooth implant according to claim 12, wherein recesses are provided in at least one of the ball-shaped projections (17) and the walls of the secondary crown (4) around the spherical cavity (18) for achieving elastic resiliency of the components.

15. The tooth implant according to claim 10, wherein the spherical cavity (18) in the secondary crown (4) extends over an angular area of more than 180°.

16. The tooth implant according to the claim 1, wherein the edges of the section of the primary crown (3) and the secondary crown (4) which extend into one another are provided with chamfers (14, 15).
